(19) United States
(12) Patent Application Publication
(10) Pub. No.: US 2006/0151224 A1
(43) Pub. Date: Jul. 13, 2006

(54) Human powered golf cart with auxiliary power source

(76) Inventor: Paul M. Vasser, Aptos, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 11/374,926

(22) Filed: Mar. 13, 2006

Related U.S. Application Data
(63) Continuation-in-part of application No. 10/867,773, filed on Jun. 16, 2004.
Application No. 10/867,773 is a division of application No. 10/350,117, filed on Jan. 24, 2003, now abandoned.

(51) Int. Cl. B62M 23/02

(52) U.S. Cl. 180/205

(57) ABSTRACT

A method of combining a golf game and exercise includes selecting a human and auxiliary powered golf cart, placing golfing equipment on the human and auxiliary powered golf cart, selecting a desired level of exercise and simultaneously activating the auxiliary power source and applying manual power to one or more pedals in the human and auxiliary powered golf cart. A system for combining a golf game and exercise is also disclosed.

### CROSS REFERENCE TO RELATED APPLICATIONS

This application is a continuation-in-part of and claims priority from U.S. patent application Ser. No. 10/867,773 filed on Jun. 16, 2004 and entitled “Human Powered Golf Cart with Auxiliary Power Source,” which is a divisional of and claimed priority to U.S. patent application Ser. No. 10/350,117 filed on Jan. 24, 2003 and entitled “Human Powered Golf Cart with Auxiliary Power Source” both of which are incorporated herein by reference in their entirety.

### BACKGROUND

The present invention relates generally to the game of golf, and more particularly, to methods and systems for playing the game of golf using a human and auxiliary powered golf cart to increase the aerobic exercise received while playing golf.

Golfing is one of America's favorite past times. Although originally designed to be performed on foot, modern day golfers can choose to use a golf cart to transport them and their golf bags on the golf course. Most of these golf carts are wholly electrically or internal-combustion powered and are designed for persons who want to golf, but do not want to walk on foot from one golf shot to the next golf shot. These types of golf carts are well known.

U.S. Pat. No. 2,973,048 issued to Jensen, outlines the use of a three wheeled motorized golf vehicle. The self-propelled vehicle is used to transport golfers and their equipment about a golf course. The self-propelled vehicle is made up of a chassis and body that cooperate to support golfers and their equipment.

U.S. Pat. No. 3,117,648 issued to Landreth, outlines the use of an electrically-powered vehicle having interconnected power and brake controls. The vehicle is small, relatively light and highly maneuverable and can also be used for industrial transportation between buildings as well as being used on a golf course.

U.S. Pat. No. 3,605,929 issued to Rolland, outlines the use of a three-wheel cart made up of three sub-assemblies designed to be easily assembled and disassembled. This includes a front steering fork assembly detachably connected by a withdrawable king-pin, with the front end of the front frame assembly, on which a driver=s seat is carried, and a rear frame assembly pivotally and detachably connected to the rear end of the front frame assembly.

U.S. Pat. No. 3,777,836 issued to Riza, outlines a one man golf cart that is assembled from seven basic structures. The seven basic structures include an L-shaped frame, a receptacle on the back and lower end of the L-shaped frame, in which a golf bag is placed, two removable rear wheels, a removable seat, a means for supporting the upper end of the golf bag and a front wheel supported by a structure adapted to secure the front end of the L-shaped frame.

U.S. Pat. No. 3,815,699 issued to Ganskopp et al., outlines the use of a cart that is lightweight and portable and may be easily disassembled for transporting from one place to another. The cart includes an elongated control frame and a drive frame, which is removably connected to the control frame and carries an electric motor and battery for driving the cart in front of the user so that the cart may be used in pacing the walking speed of the user. The control frame also includes a front guide wheel for supporting the front portion of the cart, so that it may move along unattended by the user, except for changing direction.

U.S. Pat. No. 4,113,043 issued to Palmer, outlines the use of a two or more wheeled vehicle driven by a DC electric motor having its output shaft connected to a frictional drive member which bears on the circumference of a driven wheel. The drive motor is face or flange mounted on a mounting bracket, which is constructed of a metal stamping or an integral combination of two stampings.

U.S. Pat. No. 4,387,836 issued to Laesch, outlines the use of a golf bag carrier for an adult-sized pedal-powered tricycle or quadra-cycle, including tubular axle housing portions enclosing opposite ends of the rear axle. The carrier includes an elongated golf bag supporting frame member having an upstanding rectilinear portion substantially co-extensive with most of the height of the golf bag and a base portion underlying the golf bag. The base portion also carries a support pedestal for supporting the golfbag.

U.S. Pat. No. 4,848,504 issued to Olson, outlines the use of a walking or riding power driven golf cart. The golf cart is collapsible so that it may be used selectively in walking and riding modes and is collapsible for storage and transport in the trunk of a vehicle.

U.S. Pat. No. 5,307,889 issued to Bohannan, outlines the use of a golf cart or personal utility vehicle which includes a wheeled platform, a wheeled gooseneck frame detachably secured at the rear of the platform and a detachable steering handle for turning a powered wheel on the gooseneck frame for steering purposes. A detachable upright post provides support for a conventional golf-bag and set of clubs. A forwardly facing occupant seat is detachably mounted to the gooseneck frame, placing the weight of an occupant upon the rear driving and steering wheel.

U.S. Pat. No. 5,482,304 issued to Smith, outlines the use of a trailering device for being secured between a bicycle and a pull-type golf cart, such that as the bicycle is ridden, the pull-type golf cart is pulled behind. The trailering device includes a connecting rod, a bicycle attachment member secured at one end of the connecting rod and a golf cart attachment member secured to another end of the connecting rod.

U.S. Pat. No. 5,727,642 issued to Abbott, outlines the use of a golf cart for persons who are obliged to traverse a golf course in a cart, which includes a golf bag carrier mechanism, steering assembly and adjustable seat to enable the person to swing a golf club without interference with any of these mentioned components. The seat may be rotated in either direction from the traversing axis of the cart, to enable the person to face a golf ball to be struck.

One significant drawback of the typical electrical or internal-combustion powered golf carts is that they significantly reduce the physical exercise obtained while playing golf. This minimized physical exercise may be helpful and convenient for some, however, many golf enthusiasts might desire more physical exercise (e.g., aerobic exercise) than the typical golf cart provides while still being less physical exercise than required to walk the entire golf course.

Although each of the above patents outline devices that are novel and useful, there is still room for improvement for golf cart devices. In view of the foregoing, there is a need for a human and auxiliary powered golf cart to increase the aerobic exercise received while playing golf. The human and auxiliary powered golf cart can selectively increase or decrease the level of aerobic exercise received while playing golf.

### SUMMARY

Broadly speaking, the present invention fills these needs by providing a human and auxiliary powered golf cart. It should be appreciated that the present invention can be implemented in numerous ways, including as a process, an apparatus, a system, computer readable media, or a device. Several inventive embodiments of the present invention are described below.

One embodiment provides a method of combining a golf game and exercise includes selecting a human and auxiliary powered golf cart, placing golfing equipment on the human and auxiliary powered golf cart, selecting a desired level of exercise and simultaneously activating the auxiliary power source and applying manual power to one or more pedals in the human and auxiliary powered golf cart.

The human and auxiliary powered golf cart can include a monitor and wherein the monitor displays a current exercise level of a user. The human and auxiliary powered golf cart can also include a current exercise level of a user. The monitor can includes a capability to display at least one of a user's golf score, a time of day, an ambient temperature, a user's temperature, a user's heart rate, an elapsed time, a calorie meter and a distance traveled. The monitor can be coupled to at least one sensor on the human and auxiliary powered golf cart.

Activating the auxiliary power source can include automatically activating the auxiliary power source according to the selected level of exercise. The human and auxiliary powered golf cart can include at least one of a quadracycle chassis, a tricycle chassis or a bicycle chassis. The human and auxiliary powered golf cart can include an additional cart.

Another embodiment provides a method of combining a golf game and exercise including selecting a human and auxiliary powered golf cart. The human and auxiliary powered golf cart includes a monitor that can display a current exercise level of a user. Golfing equipment is placed on the human and auxiliary powered golf cart. A desired level of exercise is selected and the auxiliary power source is applied substantially simultaneously with applying manual power to one or more pedals in the human and auxiliary powered golf cart. The auxiliary power source is automatically activated according to the selected level of exercise and monitoring a current exercise level of a user.

Another embodiment provides a human and auxiliary powered golf cart including a chassis including more than one wheel, at least one of the more than one wheel being a driven wheel. An auxiliary power source is coupled to the driven wheel and a power assist lever is coupled to the auxiliary power source. The human and auxiliary powered golf cart also includes a chain driven pedal mechanism coupled to the driven wheel and a golfing equipment storage platform.

The power assist lever can be variable. The human and auxiliary powered golf cart can also include a monitor. The human and auxiliary powered golf cart can also include a sensor coupled to the monitor. The human and auxiliary powered golf cart can also include a body.

The auxiliary power source can include at least one of a battery, an electrical fuel cell, a photoelectric power source. The auxiliary power source can include an electric motor.

The human and auxiliary powered golf cart can also include at least one of a quadracycle chassis, a tricycle chassis and a bicycle chassis. The human and auxiliary powered golf cart can also include an additional cart.

The human and auxiliary powered golf cart can also include logic for selecting a human and auxiliary powered golf cart, logic for placing golfing equipment on the human and auxiliary powered golf cart, logic for selecting a desired level of exercise and logic for simultaneously activating the auxiliary power source and applying manual power to one or more pedals in the human and auxiliary powered golf cart. The human and auxiliary powered golf cart can also include logic for monitoring a current exercise level of a user.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings.

FIGS. 1 and 2 are simplified drawings of a human and auxiliary powered golf cart, in accordance with an embodiment of the present invention.

FIG. 3 is a simplified diagram of a two-user quadracycle human and auxiliary powered golf cart, in accordance with an embodiment of the present invention.

FIG. 4 is a simplified diagram of a human and auxiliary powered bicycle golf cart, in accordance with an embodiment of the present invention.

FIG. 5 is a flowchart diagram that illustrates the method operations performed in playing a selectively aerobic round of golf, in accordance with one embodiment of the present invention.

### DETAILED DESCRIPTION

Several exemplary embodiments for a human and auxiliary powered golf cart and methods of using the human and auxiliary powered golf cart will now be described. It will be apparent to those skilled in the art that the present invention may be practiced without some or all of the specific details set forth herein.

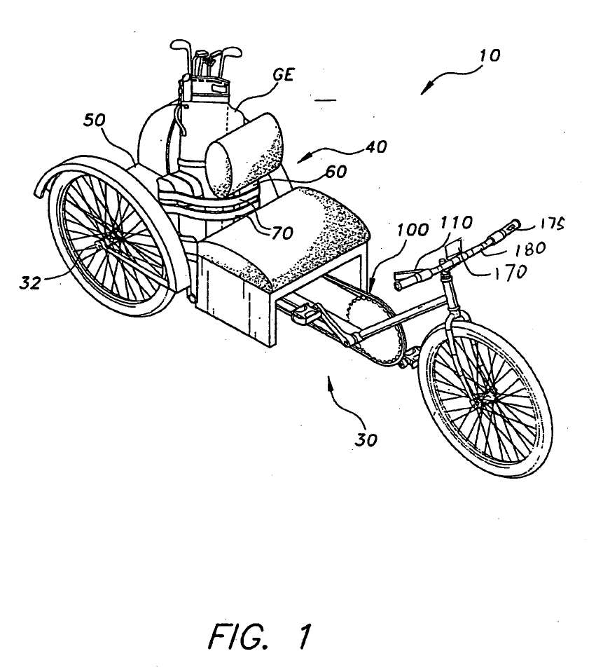

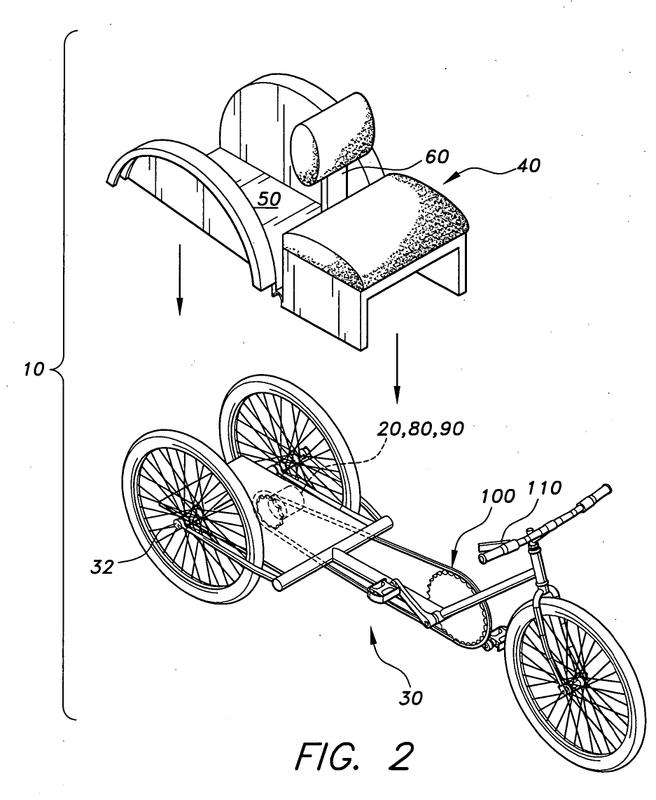

FIGS. 1 and 2 are simplified drawings of a human and auxiliary powered golf cart 10, in accordance with an embodiment of the present invention. The golf cart 10 is intended for a single user, however, with slight modification, more than one user could also be accommodated. The golf cart 10 includes an auxiliary power source 20, a chassis 30 and a body 40. One or more users can apply power to the golf cart 10 through pedals to generate power to transport the golf cart. The pedals can be coupled to at least one driven wheel via a chain driven pedal mechanism 100 such as is well known in the art.

The golf cart 10 can also include a platform or other containment 50 attached to the chassis 30 and/or body 40 (e.g., at a back axle 32 or beside the user or in front of the user). The platform or other containment 50 can be used to support or store any golfing equipment GE. One or more supports 60 can also be included. The support 60 can also include one or more straps 70. The straps 70 can be used to secure golfing equipment GE to the platform 50 and/or the support 60. The supports 60 can be approximately perpendicular to the platform 50. Alternatively, the support 60 can be any suitable angle relative to the platform 50. The body 40 can be formed from any suitable materials (e.g., wood, fiberglass, plastic, metal, etc.).

The auxiliary power source 20 can include one or more electrical power sources 80 and an electric motor 90 coupled to at least one driven wheel. The auxiliary power source 20 can be selectively used supplement any power provided by the user to the driven wheel. The electrical power source 80 can include one or more batteries or other electrical storage devices, an electrical fuel cell, a photoelectric power source or other portable electrical power sources or combinations thereof. By way of example the electrical power sources 80 can include one or more batteries of any suitable voltage and an array of photovoltaic cells that can recharge the battery. In at least one embodiment, the human powered golf cart 10 can have a powered range of approximately 8-10 miles per charge.

The golf cart 10 can also include a power assist lever 110, located in an easily accessible location (e.g., on the handlebar 180 or near other controls for the golf cart 10). The power assist lever 110 enables a user to selectively activate the auxiliary power source 20 and thereby assist the movement of the golf cart 10. The power assist lever 110 can be variable so as to allow a variable selection of a desired level of effort. The power assist lever 110 can also include multiple preselected levels of assistance in the movement of the golf cart 10.

The chassis 30 can be a bicycle, tricycle or a quadracycle chassis. The chassis includes at least one driven wheel for applying a drive force to the surface to propel the golf cart 10. It should also be understood that more than one driven wheel can be included. The human and auxiliary powered golf cart 10 can also transport more than one users (e.g., two or more). The tricycle chassis can be any suitable configuration. By way of example, the tricycle chassis can include two front wheels and one rear wheel. The tricycle chassis with two front wheels, either the rear wheel steers the tricycle chassis or both of the front wheels steer the tricycle chassis. Similarly, the tricycle chassis with two front wheels, any one or more of the three wheels can be driven by the motor 90 and the chain driven pedal mechanism 100. The tricycle chassis can include a sidecar configuration with two wheels in a single line and third wheel as an outrigger to one side of the line the other two wheels follow. It should also be understood that any of the embodiments of the human powered golf carts 10, 120, 130 can be in a recumbent form where the user is sitting in a somewhat reclining position while operating the golf cart.

The human and auxiliary powered golf cart 10 can also include a monitor 170. The monitor 170 can display multiple important facts for the user. By way of example the monitor can record the user's golf score, time of day, ambient temperature, user's temperature, user's heart rate, an elapsed time the user has pedaled the golf cart 10, a calorie meter recording the estimated calories consumed by the user pedaling the golf cart, a distance traveled, and other useful facts. The monitor 170 can be coupled to the power assist lever 110 and/or the auxiliary power source 20. The monitor 170 can control either one or both of the power assist lever 110 and the auxiliary power source 20.

The golf cart 10 can also include one or more sensors 175 in handlebar/steering mechanism 180. The handlebar/steering mechanism 180 is coupled to at least one of the wheels for controlling the direction of the golf cart 10. When the one or more sensors 175 are in contact with the user (e.g., a user's hand, leg, chest, etc.), the sensors can collect the user's heart rate and temperature or other bodily functions that are helpful for the user to monitor while exercising. By way of example, the sensor 175 can detect the user's heart rate. The sensor communicates the user's heart rate to the monitor 170. The monitor 170 displays the user's heart rate. The user can use the heart rate displayed in the monitor 170 and the power assist lever 110 to achieve and maintain a desired heart rate as a heart rate is a commonly used indicator to indicate a user's current exercise level.

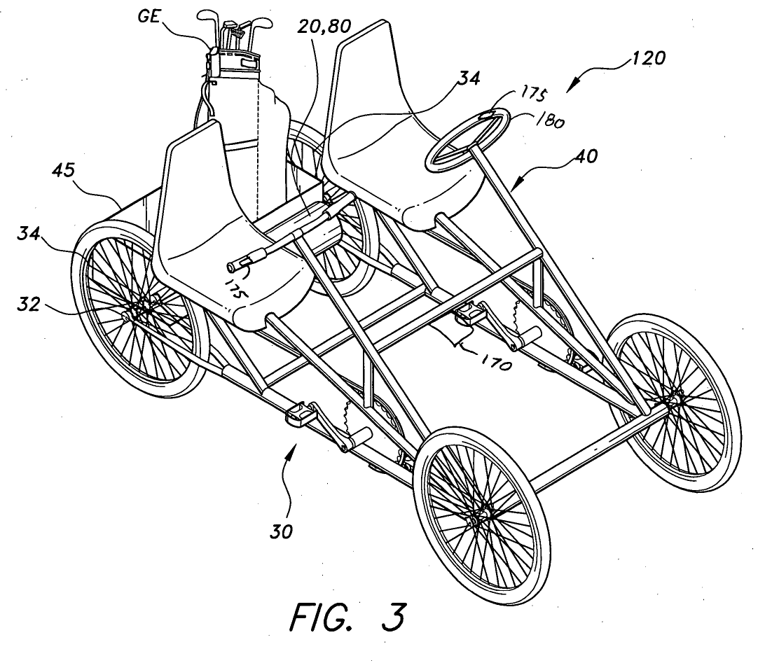

FIG. 3 is a simplified diagram of a two-user quadracycle human and auxiliary powered golf cart 120, in accordance with an embodiment of the present invention. The quadracycle human and auxiliary powered golf cart 120 includes a quadracycle chassis 30 and a body 40. At least one of the two users can generate power to transport the two users and the golf cart 120. The golf cart 120 also includes an open top platform 45 attached to the chassis 30 to support or store any golfing equipment GE. The open top platform 45 can be situated between the two rear wheels 34. The open top platform 45 can include sufficiently high enough walls so that additional supports (e.g., support 60 and straps 70 of FIG. 1 above) are unnecessary. However, it should be understood that the open top platform 45 can also include one or more supports 60 and straps 70 to secure any golfing equipment GE. The walls of the open top platform 45 can be suitable tall enough to allow any golfing equipment GE to rest upright against one of the walls.

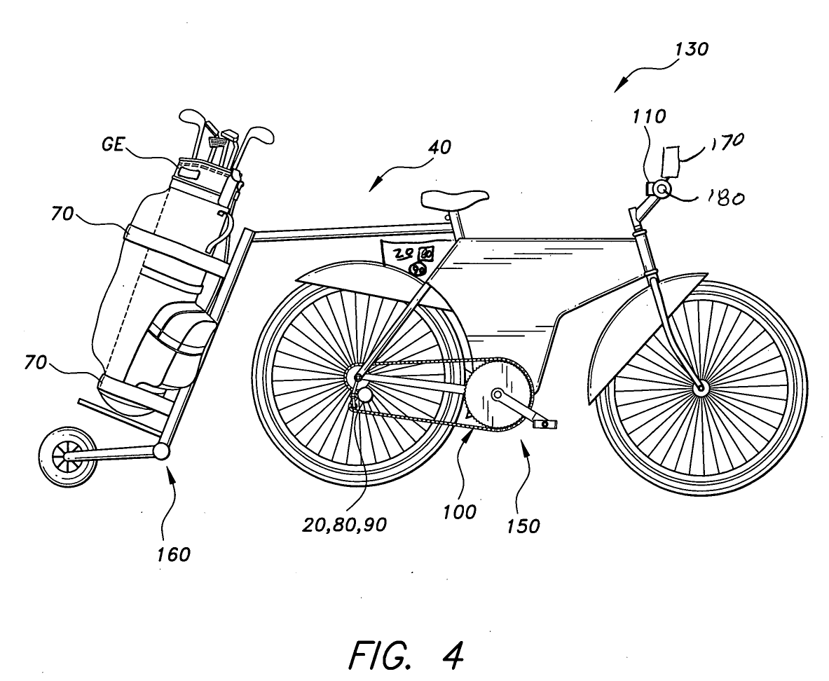

FIG. 4 is a simplified diagram of a human and auxiliary powered bicycle golf cart 130, in accordance with an embodiment of the present invention. The golf cart 130 includes a bicycle-type chassis 150 and a body 40. A user pedals the golf cart 130 to generate power to transport the golf cart. An additional cart 160 is attached to the bicycle chassis 150 and the body 40. The additional cart 160 can support and transport any golfing equipment GE. The additional cart 160 can include one or more wheels. The additional cart 160 can also include one or more straps 70 to secure the golfing equipment GE to the cart.

The human and auxiliary powered golf carts 10, 120 and 130 encourage users (i.e., golfers) who need to use a golf cart to use as an alternative to a typical fully powered golf cart. The human and auxiliary powered golf carts 10,120,130 provide a healthier alternative to riding in a typical fully powered golf cart. Support for providing an alternative way of exercising, while playing golf, will be good public relations and positive publicity for any golf course. Each of the human and auxiliary powered golf carts 10,120 and 130 are lightweight and maneuverable, so that they can be easily negotiated around cart pathways and fairway roughs.

Combining a game of and aerobic exercise is a desirable goal to increase fitness, increase exercise, reduce weight, therapeutically reforming and rebuilding muscle tone and strength and overall aerobic fitness. Unfortunately, a typical game of golf requires the golfer to choose between the exercise extremes a considerable exertion of walking the golf course and carrying or pulling his golf equipment, or a relatively negligible exertion of riding in a typical fully powered golf cart.

What is needed is an aerobic exercise option residing between little to no exertion in riding the typical fully powered golf cart and the maximum exertion of walking the entire golf course. The human and auxiliary powered golf carts 10, 120 and 130 allow the golfer to select a desired level of exertion from any one of a multitude exertion levels residing between little to no exertion in riding the typical fully powered golf cart and the maximum exertion of walking the entire golf course. The human and auxiliary powered golf carts 10, 120 and 130 therefore allow each one of the one or more of the golfers to selectively combine a desired level of exercise with golf.

By way of example, a single golfer can select one of the human and auxiliary powered golf carts 10, 120 and 130, load his golf equipment in the selected human powered golf cart, select a desired level of exercise and activate the auxiliary power source 20 to maintain the selected level of exercise. Similarly, two or more golfers can select one of the human powered golf carts suitable for the desired number of the golfers, load their golf equipment in the selected human powered golf cart, individually select a desired level of exercise and activate the auxiliary power source 20 to maintain the individually selected levels of exercise. More specifically, one golfer may wish to have moderate level of exertion where the second golfer desires almost no exertion. The auxiliary power source 20 can support the individually selected levels of exercise.

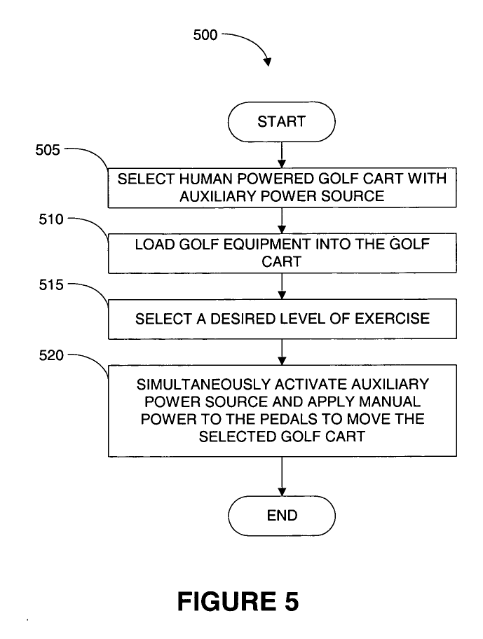

FIG. 5 is a flowchart diagram that illustrates the method operations 500 performed in playing a selectively aerobic round of golf, in accordance with one embodiment of the present invention. In an operation 505, one or more golfers select a human and auxiliary powered golf cart 10, 120 and 130 with an auxiliary power source 20. In an operation 510, the one or more golfers load and optionally secure their golf equipment GE into the selected human and auxiliary powered golf cart 10, 120 and 130.

In an operation 515, each of the one or more golfers individually select a desired level of exercise. In an operation 520, the one or more golfers simultaneously activate the auxiliary power source 20 to maintain the individually selected levels of exercise and apply manual power to the pedals to cause the selected golf cart to move.

The monitor 170 can include automated controls to automatically control the level of aerobic exercise. By way of example, the golfer can enter a desired heart rate into the monitor 170 and the monitor can automatically operate the power assist lever 110 and/or the auxiliary power source 20 to achieve and maintain the desired heart rate.

The human and auxiliary powered golf cart 10, 120 and 130 provides human driven transportation for golfers that may be unable to walk long distances, but still desire a selected level of exercise while playing golf. The golf cart 10, 120 and 130 has an auxiliary power source 20 that is available when needed or desired so as to allow a golfer to selectively increase or decrease the golfer's level of exertion. The golf cart 10, 120 and 130 is lightweight and maneuverable, so that it can be easily negotiated on cart paths and fairway roughs.

It will be further appreciated that the instructions represented by the operations in the above figures are not required to be performed in the order illustrated, and that all the processing represented by the operations may not be necessary to practice the invention. Further, the processes described in any of the above figures can also be implemented in software stored in any one of or combinations of the RAM, the ROM, or the hard disk drive. At least a portion of the invention can also be embodied as computer readable code on a computer readable medium. The computer readable medium is any data storage device that can store data that can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method of combining a golf game and exercise comprising:
selecting a human and auxiliary powered golf cart;
placing golfing equipment on the human and auxiliary powered golf cart;
selecting a desired level of exercise; and
simultaneously activating the auxiliary power source and applying manual power to one or more pedals in the human and auxiliary powered golf cart.

2. The method of claim 1, wherein the human and auxiliary powered golf cart includes a monitor and wherein the monitor displays a current exercise level of a user.

3. The method of claim 2, further comprising monitoring a current exercise level of a user.

4. The method of claim 2, wherein the monitor includes a capability to display at least one of a user's golf score, a time of day, an ambient temperature, a user's temperature, a user's heart rate, an elapsed time, a calorie meter and a distance traveled.

5. The method of claim 4, wherein the monitor is coupled to at least one sensor on the human and auxiliary powered golf cart.

6. The method of claim 1, wherein activating the auxiliary power source includes automatically activating the auxiliary power source according to the selected level of exercise.

7. The method of claim 1, wherein the human and auxiliary powered golf cart includes a quadracycle chassis.

8. The method of claim 1, wherein the human and auxiliary powered golf cart includes a bicycle chassis.

9. The method of claim 1, wherein the human and auxiliary powered golf cart includes an additional cart.

10. The method of claim 1, wherein the human and auxiliary powered golf cart includes a tricycle chassis.

11. A method of combining a golf game and exercise comprising:
selecting a human and auxiliary powered golf cart, wherein the human and auxiliary powered golf cart includes a monitor and wherein the monitor displays a current exercise level of a user;
placing golfing equipment on the human and auxiliary powered golf cart;
selecting a desired level of exercise;
simultaneously activating the auxiliary power source and applying manual power to one or more pedals in the human and auxiliary powered golf cart wherein automatically activating the auxiliary power source according to the selected level of exercise; and
monitoring a current exercise level of a user.

12. A human and auxiliary powered golf cart comprising:
a chassis including more than one wheel, at least one of the more than one wheel being a driven wheel;
an auxiliary power source coupled to the driven wheel
a power assist lever coupled to the auxiliary power source;
a chain driven pedal mechanism coupled to the driven wheel;
a golfing equipment storage platform;

13. The human and auxiliary powered golf cart of claim 12, wherein the power assist lever is variable.

14. The human and auxiliary powered golf cart of claim 12, wherein the human and auxiliary powered golf cart includes a monitor.

15. The human and auxiliary powered golf cart of claim 12, further comprising a sensor coupled to the monitor.

16. The human and auxiliary powered golf cart of claim 12, further comprising a body.

17. The human and auxiliary powered golf cart of claim 12, wherein the auxiliary power source includes at least one of a battery, an electrical fuel cell, a photoelectric power source.

18. The human and auxiliary powered golf cart of claim 12, wherein the auxiliary power source includes an electric motor.

19. The human and auxiliary powered golf cart of claim 12, further comprising a quadracycle chassis.

20. The human and auxiliary powered golf cart of claim 12, further comprising a bicycle chassis.

21. The human and auxiliary powered golf cart of claim 12, further comprising an additional cart.

22. The human and auxiliary powered golf cart of claim 12, further comprising a tricycle chassis.

23. The human and auxiliary powered golf cart of claim 12, further comprising:
logic for selecting a human and auxiliary powered golf cart;
logic for placing golfing equipment on the human and auxiliary powered golf cart;
logic for selecting a desired level of exercise; and
logic for simultaneously activating the auxiliary power source and applying manual power to one or more pedals in the human and auxiliary powered golf cart.

24. The human and auxiliary powered golf cart of claim 23, further comprising logic for monitoring a current exercise level of a user.
